(19) United States
(12) Patent Application Publication
(10) Pub. No.: US 2017/0269566 A1
(43) Pub. Date: Sep. 21, 2017

(54) OPERATION MANAGEMENT METHOD FOR MACHINE TOOL

(71) Applicant: FANUC CORPORATION, Yamanashi (JP)

(72) Inventor: Yoshitaka Ogawa, Minamitsuru-gun (JP)

(73) Assignee: FANUC CORPORATION, Yamanashi (JP)

(21) Appl. No.: 15/459,094

(22) Filed: Mar. 15, 2017

(30) Foreign Application Priority Data
Mar. 17, 2016 (JP) 2016-053500

(51) Int. Cl. G05B 19/048

(52) U.S. Cl. CPC G05B 19/048; G05B 2219/24015; G05B 2219/50185

(57) ABSTRACT

An operation management method for machine tools is provided for collectively managing a plurality of events generated by a series of events. The operation management method for the machine tools includes a collecting step of monitoring an operation state of the machine tools, and collecting events that are generated by operations thereof, and a grouping step of dividing into a plurality of groups a collected plurality of the events and storing the same in a storage medium. In the grouping step, at each time that a mode which is set in the machine tools is switched, one event or two or more events that are generated during the set mode are grouped together and stored.

### CROSS-REFERENCE TO RELATED APPLICATION

This application is based upon and claims the benefit of priority from Japanese Patent Application No. 2016-053500 filed on Mar. 17, 2016, the contents of which are incorporated herein by reference.

### BACKGROUND OF THE INVENTION

Field of the Invention

The present invention relates to an operation management method for a machine tool, which in a numerically controlled (NC) machine tool that is driven and controlled by a computer, events such as a history of various alarms that occur during operations, as well as changes in operation states thereof are collected and managed.

Description of the Related Art

In a conventional operation management method, events such as an alarm history and changes in the operation states of a machine tool are collected, and the collected events are subjected to analysis. In addition, information of the results of such analysis is added respectively to each of the events.

When this type of operation management is carried out, from among information of many events that occur simultaneously, by way of visual inspection or the like, an operator selects important events as well as events that are less important. However, the selection task by the operator is quite difficult, and further, as there are individual differences in the knowledge of operators in relation to target processes, a problem occurs in that it is difficult for the selection task to be carried out uniformly. Therefore, in Japanese Laid-Open Patent Publication No. 10-171521, a method of providing notification and deterrence of events is disclosed, in which, during monitoring of operations of process states, a master-slave relationship between a plurality of events to be monitored (alarms, changes in the operation states) is determined utilizing an event correlation table, and a plurality of occurring events are notified in an efficient manner. More specifically, in the method of providing notification and deterrence of events according to Japanese Laid-Open Patent Publication No. 10-171521, a deterrence time is added to the master-slave relationship between events that include plural alarms and changes in the operation state, generated in conjunction with operations and monitoring of the plant, and the master-slave relationship with the deterrence time added thereto is defined beforehand as an event correlation. In addition, when a certain event occurs, the event correlation table is referred to, and a judgment process as to whether to notify the event to the operator or to deter the notification is carried out, and the result of the judgment process is output to a required output means.

### SUMMARY OF THE INVENTION

In the aforementioned conventional management method and system for events and data, even if the multiple events are a series of events, since the events cannot be managed collectively, such a series of events has been determined as separate individual events.

As a series of events, there exist, for example, (1) the case of an event in which a tool is caused to collide with a workpiece due to a manual operation and an event in which the tool is caused to collide again with the workpiece when the tool is returned rapidly, and (2) the case in which multiple alarm events (accompanying alarms) occur simultaneously.

In particular, in the case of the conventional technique, time and effort is expended, since it is necessary to add the same analysis result as information for each event, even if the multiple events occur as a series of events. Further, in order to determine that a plurality of events is actually a series of events, it is necessary to prepare an event correlation table in which each of the events are associated in advance.

The present invention has been devised taking into consideration the aforementioned problems, and has the object of providing an operation management method for a machine tool which is capable of collectively managing a plurality of events generated by a series of events.

An embodiment of the present invention is characterized by an operation management method for a machine tool, comprising a collecting step of monitoring an operation state of the machine tool, and collecting events that are generated by operations thereof, and a grouping step of dividing into a plurality of groups a collected plurality of the events and storing same in a storage medium, wherein, in the grouping step, at each time that a mode which is set in the machine tool is switched, one event or two or more events that are generated during the set mode are grouped together and stored.

In accordance with this configuration, a plurality of generated events are grouped together automatically each time that the mode of the machine tool is switched. Therefore, the series of events can be grouped together easily. Consequently, there is no need to add the same analysis result as information for each event. Further, since the events are grouped together each time that the mode of the machine tool is switched, management of the machine tool is facilitated.

The embodiment of the present invention is characterized by the operation management method for the machine tool, wherein modes of the machine tool may include at least two modes from among a manual feeding mode, an editing mode, and an automatic machining mode. In accordance with this feature, the series of events can be grouped together in a simple manner.

The embodiment of the present invention is characterized by the operation management method for the machine tool, wherein in the grouping step, in a case that the mode of the machine tool is the automatic machining mode, in each of respective machining cycles, one event or two or more events that are generated and collected during the machining cycle may be grouped together. In accordance with this feature, the series of events can be grouped together in a simple manner.

The embodiment of the present invention is characterized by the operation management method for the machine tool, and may further include a list displaying step of displaying in a list on a display unit a plurality of grouped events that are stored in the storage medium. In accordance with this feature, the operator can easily observe the events of each of the groups.

The embodiment of the present invention is characterized by the operation management method for the machine tool, which may further include an information adding step of associating with and storing in a designated group, supplemental information for the group that has been designated and input by an operator. In accordance with this feature, an analysis result can be added to each of the groups.

The embodiment of the present invention is characterized by the operation management method for the machine tool, and may further comprise a selecting step of selecting, in response to an operation of an operator, any one of the groups from among the plurality of groups, an extracting step of extracting one of the groups having an event that is similar in content with an event of the selected group, and a displaying step of displaying the extracted group. In accordance with this feature, a similar series of events can easily be observed.

The embodiment of the present invention is characterized by the operation management method for the machine tool, wherein the events may include at least one of an alarm and a change in an operation state, generated by an operation. In accordance with this feature, the operator is capable of recognizing the alarm or the change in the operation state.

The embodiment of the present invention is characterized by the operation management method for the machine tool, wherein the operation management method may manage operations of a plurality of machine tools, in the collecting step, events may be collected that occur in each of the machine tools, and in the grouping step, for each of the machine tools, a collected plurality of the events may be divided into a plurality of the groups and stored in the storage medium. In accordance with this feature, management of the plurality of machine tools is facilitated.

According to the present invention, a plurality of generated events are grouped together automatically each time that the mode of the machine tool is switched. Therefore, the series of events can be grouped together easily. Consequently, there is no need to add the same analysis result as information for each event. Further, since the events are grouped together each time that the mode of the machine tool is switched, management of the machine tool is facilitated.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall system diagram made up from a plurality of machine tools, and an operation management device, in which there is implemented the operation management method for a machine tool according to an embodiment of the present invention;

FIG. 2 is a schematic diagram showing the configuration of the operation management device;

FIG. 3 is a diagram for describing groupings performed by a grouping unit shown in FIG. 2;

FIG. 4A is a diagram showing group information that is stored in a storage medium shown in FIG. 2;

FIG. 4B is a diagram showing detailed information of events corresponding to the group information that is stored in the storage medium shown in FIG. 2;

FIG. 5 is a diagram showing the group information shown in FIG. 4A after supplemental information (comments and materials) have been added thereto by an operator;

FIG. 6 is a diagram showing a display example of a plurality of events displayed in a list;

FIG. 7 is a diagram showing a display example of group information of groups having events therein that are similar in content to events of a selected group;

FIG. 8 is a flowchart showing a grouping completion operation by the grouping unit;

FIG. 9 is a flowchart showing a sorting operation performed on groups of events by the grouping unit;

FIG. 10 is a flowchart showing a group extraction operation by an extraction unit;

FIG. 11 is a diagram for describing a method of determining a priority of the groups by the extraction unit;

FIG. 12A is a diagram showing group information of a group to which comments or materials selected by an operator have not been added; and

FIG. 12B is a diagram showing detailed information of events of the group shown in FIG. 12A.

### DESCRIPTION OF THE PREFERRED EMBODIMENTS

A preferred embodiment concerning an operation management method for a machine tool according to the present invention will be exemplified and described in detail below with reference to the accompanying drawings.

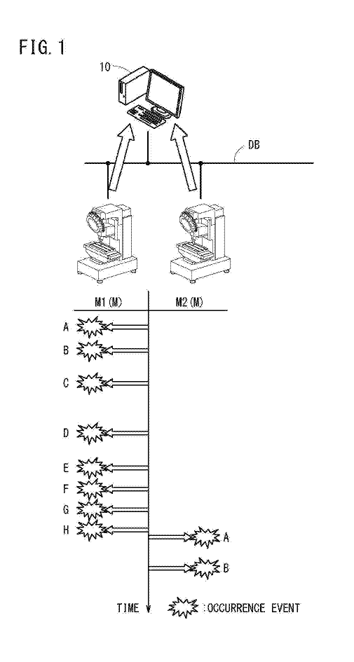

FIG. 1 is an overall system diagram made up from a plurality of machine tools M (M1, M2), and an operation management device 10, in which there is implemented the operation management method for a machine tool according to an embodiment of the present invention. The operation management device 10 and the plurality of machine tools M1, M2 are connected through a data bus DB. The machine tools M1, M2 transmit to the operation management device 10 through the data bus DB events that are generated by operations of the machine tools M1, M2. Communications between the machine tools M1, M2 and the operation management device 10 may be carried out in a wireless manner. The events include at least one of alarms and changes in the operation states, generated by the operations.

In FIG. 1, events that are generated by the machine tool M1 and the machine tool M2 are shown along a common time axis. An exemplary case is shown in which eight events A through H are generated by the machine tool M1, and two events A, B are generated by the machine tool M2. Moreover, the machine number of the machine tool M1 is 1, and the machine number of the machine tool M2 is 2.

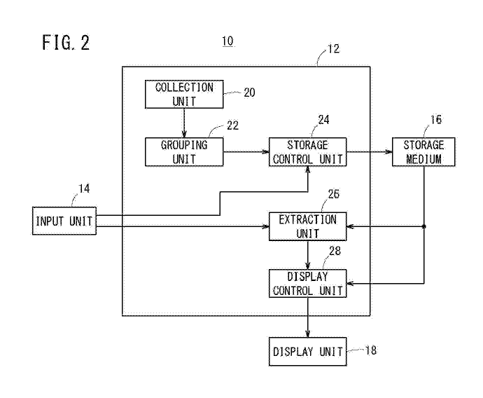

FIG. 2 is a schematic diagram showing the configuration of the operation management device 10. The operation management device 10 is equipped with a control unit 12, an input unit 14, a storage medium 16, and a display unit 18. The control unit 12 monitors the machine tools M (M1, M2), collects events generated by operations thereof, divides the collected plurality events into a plurality of groups, and stores the events and groups in the storage medium 16. The control unit 12 includes a computer such as a CPU or the like, and a memory in which there are stored programs and a grouping definition file. By executing such programs, the computer functions as the control unit 12 of the present embodiment.

The input unit 14 is an operating device for the purpose of inputting data. The input unit 14 is constituted by a mouse and a keyboard, etc. The storage medium 16 is a medium in which events collected by the control unit 12 are stored, and for example, is constituted by a flash memory, a hard disk, or the like. The display unit 18 is constituted by a liquid crystal display or an organic EL display or the like, and serves to display the events that were stored in the storage medium 16.

The control unit 12 is equipped with a collection unit 20, a grouping unit 22, a storage control unit 24, an extraction unit 26, and a display control unit 28. The collection unit 20 collects the generated events, and outputs the collected events to the grouping unit 22.

The grouping unit 22 divides a plurality of events into a plurality of groups, and outputs the same to the storage control unit 24. In principle, each time that modes set for the machine tools M are switched, the grouping unit 22 groups one event or two or more events that have occurred during the set modes. As modes of the machine tools M, there are included a manual feeding mode (JOG), an editing mode (EDIT), and an automatic machining mode (AUTO), etc.

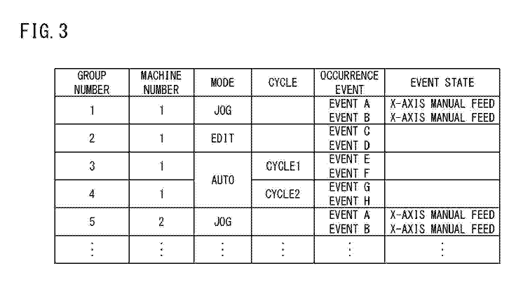

FIG. 3 is a diagram for describing groupings performed by the grouping unit 22. As shown in FIG. 3, for example, when the modes of the machine tools M are switched from the manual feeding mode (JOG) to the editing mode (EDIT), two events (events A and B) generated during the manual feeding mode are grouped together as one group. Events A and B are events generated by an X-axis manual feed.

Further, when the modes of the machine tools M are the automatic machining mode (AUTO), for each machining cycle, the grouping unit 22 groups together the events that have occurred during a one time (one) machining cycle as one group. For example, when shifting from a machining cycle 1 to a machining cycle 2, two events (events E and F), which were generated in the machining cycle 1, are grouped together as one group. Further, when the machining cycle 2 is completed, and the mode is switched to the manual feeding mode (JOG), two events (events G, H), which were generated in the machining cycle 2, are grouped together as one group. The grouping unit 22 groups events that are generated by each of the machine tools M (M1, M2).

The grouping unit 22 increments a group number every time that a grouping is made, and attaches the incremented group number to the next group. Every time that the mode is switched, and every time a machining cycle comes to an end, the machine tools M transmit signals indicative of that fact to the control unit 12. Additionally, on the basis of such signals, the grouping unit 22 groups the events together. Further, the grouping unit 22 may group together the events that have occurred (also referred to as “occurrence events”) on the basis of the grouping definition file.

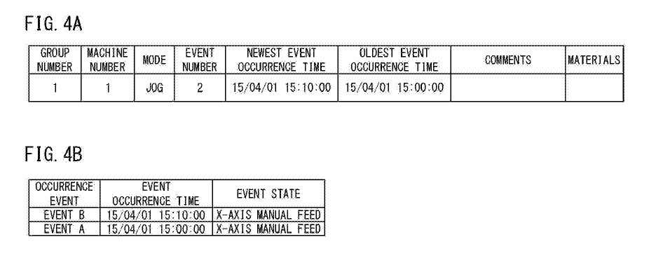

The storage control unit 24 stores the grouped events in the storage medium 16 as one group. FIGS. 4A and 4B are diagrams showing the contents of information that are stored in the storage medium 16 by the storage control unit 24. More specifically, FIG. 4A is a diagram showing group information that is stored in the storage medium 16, whereas FIG. 4B is a diagram showing detailed information of events corresponding to the group information that is stored in the storage medium 16.

As shown in FIG. 4A, a group number, a machine number, a mode, an event number, a newest event occurrence time, an oldest event occurrence time, comments, and materials are stored as the group information. In the example shown in FIG. 4A, group information of the group number “1” is represented. The event number is indicative of the number of events that have occurred. The newest (most recent) event occurrence time is indicative of the occurrence time of the newest or most recent event in the group. The oldest event occurrence time is indicative of the occurrence time of an event (the oldest event) that occurred first within the group.

As shown in FIG. 4B, an occurrence event, an event occurrence time, and an event state (event content) are stored as detailed event information. In the example shown in FIG. 4B, detailed event information corresponding to the group of group number “1” is represented. Such group information and the detailed event information therefor are stored in association with each other. Moreover, since the comments and materials (supplementary information) are information added by the operator, they are grouped together by the grouping unit 22, and are added after having been stored at one time in the storage medium 16.

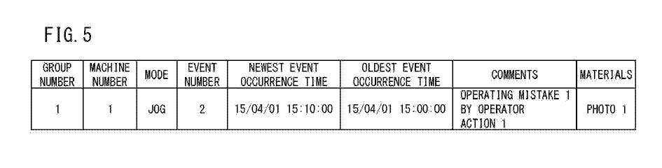

FIG. 5 is a diagram showing the group information shown in FIG. 4A after supplemental information (comments and materials) have been added thereto by an operator. As shown in FIG. 5, an “operation mistake 1 by operator” and an “action 1” (countermeasure 1) are stored as a comment, whereas a “photo 1” is stored as a material. The operator operates the input unit 14, whereby such supplemental information can be added (appended). The storage control unit 24 adds to the group information stored in the storage medium 16 the supplemental information that was input in accordance with the operation of the input unit 14 by the operator. At this time, the storage control unit 24 adds the entered supplemental information to the group information of the group that was specified in accordance with the operation of the input unit 14 by the operator.

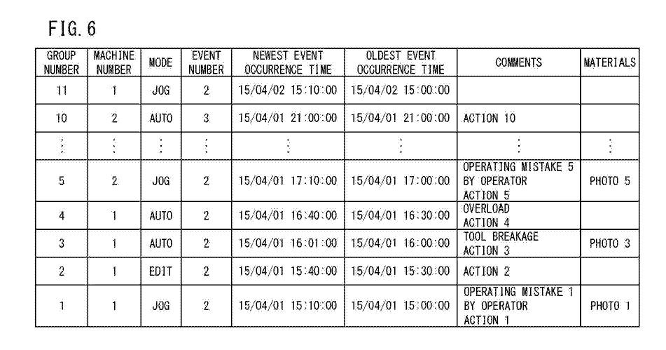

The display control unit 28 reads out the plurality of events that were stored in the storage medium 16, and causes the display unit 18 to display the events in the form of a list. FIG. 6 is a diagram showing a display example of a plurality of events displayed in the list. In the list display, group information of a plurality of groups (refer to FIG. 4A) is displayed in the form of a list. Among the plurality of groups that are displayed in the list, by the operator operating the input unit 14 and designating (selecting) one of the groups, the above-described supplemental information can be input.

At this time, when a group is selected by the operator, the extraction unit 26 extracts one or more groups having an event similar to the content of the event of the selected group from among the plurality of groups that are stored in the storage medium 16. In addition, the extraction unit 26 outputs to the display control unit 28 the group information of the extracted groups. The display control unit 28 displays the extracted group information on the display unit 18. At this time, if there are a plurality of extracted groups, the extraction unit 26 appends a priority of the group to the group information, and then outputs the group information to the display control unit 28. The display control unit 28 displays the plural items of group information according to the priority that was appended to the group information. The extraction unit 26 will be described in detail later.

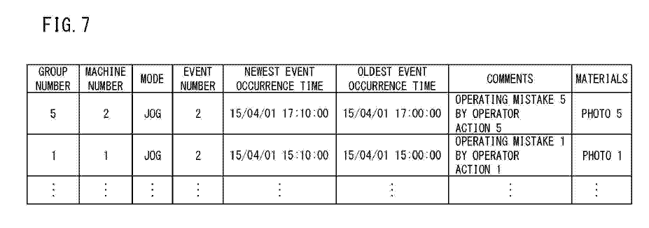

FIG. 7 is a diagram showing a display example of group information of groups having events therein that are similar in content to events of a selected group. For example, in the case that a group having the group number “11” is selected by the operator, the group information of group number “5” having the highest priority is displayed in a highest position, whereas the group information of other group numbers having a lower priority are displayed in a descending order.

Accordingly, by the operator considering the group information of the displayed groups, it becomes easy for the operator to input supplemental information (comments, materials) to be added to the group information of a group selected by the operator (a group to which comments or materials are not yet added). Further, in the case that the operator selects a group to which comments or materials have been added as well, since group information of one or more groups similar to the selected group are displayed, it is easy to edit the comment or material that has been added to the selected group.

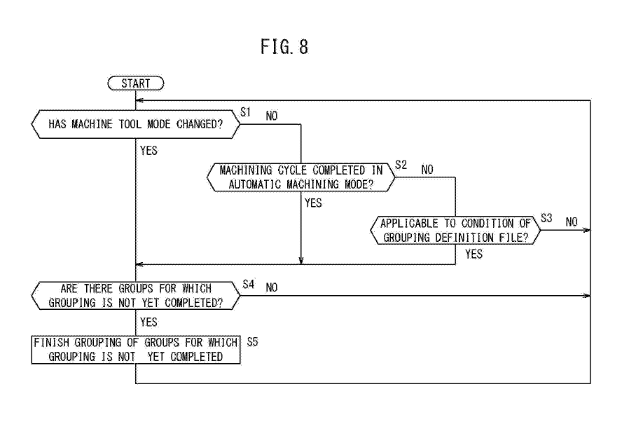

FIG. 8 is a flowchart showing a grouping completion operation effected by the grouping unit 22. The grouping unit 22 determines whether or not modes of the machine tools M have been changed (switched) (step S1). If it is determined in step S1 that the modes of the machine tools M have been switched, the routine proceeds to step S4.

On the other hand, if it is determined in step S1 that the modes of the machine tools M have not been switched, it is determined whether or not a one time (one) machining cycle in the automatic machining mode has ended (been completed) (step S2). In step S2, if it is determined that the machining cycle in the automatic machining mode has ended (been completed), the routine proceeds to step S4.

On the other hand, in step S2, if it is determined that the machining cycle in the automatic machining mode has not ended (been completed), it is determined whether or not the operation states of the machine tools M are applicable to the condition of the grouping definition file (step S3). In step S3, in the case it is determined that the operation states are applicable to the grouping definition file, the routine proceeds to step S4, whereas in the case it is determined that the operation states are not applicable to the grouping definition file, the routine returns to step S1.

As a condition of the grouping definition file, there may be, for example, the condition of “grouping when an event of a predetermined event state occurs”, and there may be, for example, the condition of “grouping when events of a plurality of predetermined event states occur in a predetermined order”. In this manner, conditions for grouping can be determined arbitrarily by the grouping definition file.

Upon proceeding to step S4, it is determined whether or not there is a group for which grouping has not yet been completed. In step S4, if it is determined that there is a group for which grouping has not been completed, then grouping is performed and completed on the group for which grouping has not been completed (step S5), and thereafter, the routine returns to step S1. On the other hand, in step S4, if it is determined that there are not any groups for which grouping has not been completed, the routine returns directly to step S1.

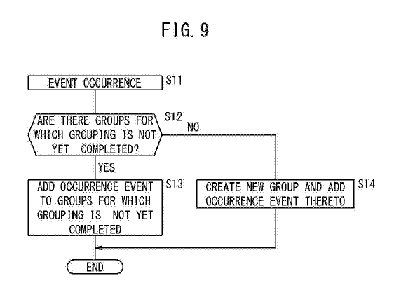

FIG. 9 is a flowchart showing a sorting operation for sorting events into groups by the grouping unit 22. When an event is generated by the machine tools M (step S11), it is determined whether or not there are any groups for which grouping has not been completed (step S12).

In step S12, if it is determined that there is a group for which grouping has not been completed, then the generated event is added to the group for which grouping has not yet been completed (step S13). On the other hand, in step S12, if it is determined that there are not any groups for which grouping has not been completed, then a new group is created, and the generated event is added thereto (step S14).

At a stage when grouping by the grouping unit 22 is completed, the storage control unit 24 may store events belonging to that group in the storage medium 16 all at once, or may sequentially store the events in the storage medium 16 at the time that such events occur. In the case that the events are stored sequentially in the storage medium 16, the number of events, the newest event occurrence time, etc., of the group information are updated.

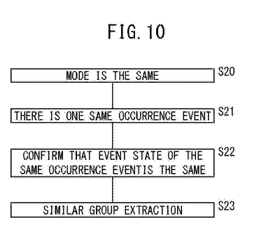

FIG. 10 is a flowchart showing a group extraction operation performed by the extraction unit 26. Among the plurality of groups that are stored in the storage medium 16, groups having modes that are the same as that of the group selected by the operator are designated as candidates (step S20).

Next, among the groups that were designated as candidates, there is further specified therein at least one group, which is a group having a same event as the event of the group selected by the operator (step S21).

Next, it is confirmed whether an event state of the specified group is the same as the event state of the group selected by the operator (step S22), and only groups having the same event state are extracted (step S23).

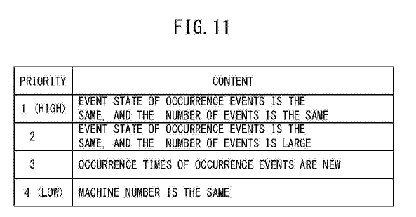

FIG. 11 is a diagram for describing a method of determining a priority of the groups by the extraction unit 26. A group of priority 1 having the highest priority is a group in which “the event state of the occurrence events is the same and the number of the events is the same”, and next, a group of priority 2 having the second highest priority is a group in which “the event state of the occurrence events is the same and the number of events is large”. In addition, a group of priority 3 having the next highest priority is a group in which “the occurrence times of the occurrence events are new”. Lastly, a group of priority 4 having the lowest priority is a group in which “the machine number is the same”.

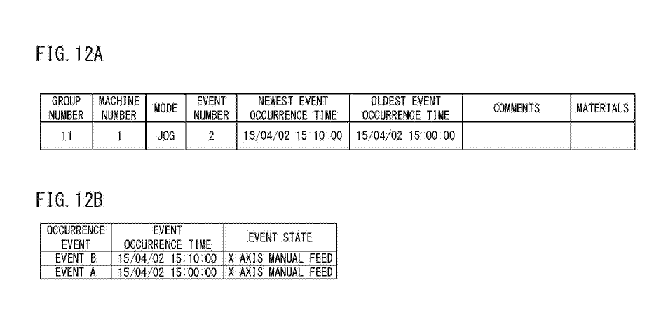

For example, assume that the operator has selected the group of group number “11”. FIG. 12A is a diagram showing group information of the group of group number “11”, whereas FIG. 12B is a diagram showing detailed information of events thereof. If the mode is the same as that of the group of group number “11”, there is at least one same occurrence event therein, while in addition, as shown in FIG. 3, groups having the same event state become groups of at least group numbers “1” and “5”. Further, since the event state of the occurrence events of group numbers “1” and “5” is the same as that of the group number “11”, and the number of events is the same, both of the groups are given priority 1. However, since the event occurrence time of the group of group number “5” is more recent, as shown in FIG. 7, the group information of the group of group number “5” is displayed in the highest position, and the information of the group of group number “1” is displayed below that of group number “5”.

In this manner, in the operation management method for a machine tool according to the present embodiment, the operation states of the machine tools M are monitored, events that occur due to operations thereof are collected, and the collected plurality of events are divided into a plurality of groups and stored in the storage medium 16. At this time, in every instance that the modes set in the machine tools M are switched, one event or two or more events that are generated during the set mode are grouped together and stored. In accordance with this feature, a plurality of generated events are grouped together automatically each time that the modes of the machine tools M are switched. Therefore, the series of events can be grouped together easily. Consequently, there is no need to add the same analysis result as information for each event. Further, since the events are grouped together each time that the modes of the machine tools M are switched, management of the machine tools M is facilitated.

The modes of the machine tools M may include at least two modes from among a manual feeding mode, an editing mode, and an automatic machining mode. In the case that the mode of the machine tools M is the automatic machining mode, in each of respective machining cycles, one event or two or more events that are generated and collected during the machining cycle may be grouped together. In accordance with this feature, the series of events can be grouped together in a simple manner.

There may further be displayed in the form of a list on the display unit 18 a plurality of grouped events that are stored in the storage medium 16. In accordance with this feature, the operator can easily observe the events of each of the groups. Supplemental information for a group that has been designated and input by an operator may be associated and stored in the designated group. In accordance with this feature, an analysis result can be added to each of the groups.

In response to an operation of the operator, any one of the groups from among the plurality of groups may be selected, a group having an event that is similar in content with an event of the selected group may be extracted, and the extracted group may be displayed. In accordance with this feature, a similar series of events can easily be observed. Further, when supplemental information is added (input) thereto, a similar series of events can easily be observed.

The events may include at least one of alarms and changes in the operation states, generated by the operations. In accordance with this feature, the operator is capable of recognizing the alarms or the changes in the operation states.

The operation management method for a machine tool according to the present embodiment serves to manage operations of a plurality of machine tools M. Events that are generated in each of the machine tools M are collected, and in each of the machine tools M, the collected plurality of events are divided into a plurality of groups and stored in the storage medium 16. In accordance with this feature, management of the machine tools M is facilitated.

The operation management method for a machine tool according to the present invention is not limited to the above described embodiments. It is a matter of course that variations and modifications can be adopted without deviating from the gist of the present invention.

What is claimed is:

1. An operation management method for a machine tool, comprising:
a collecting step of monitoring an operation state of the machine tool, and collecting events that are generated by operations thereof; and
a grouping step of dividing into a plurality of groups a collected plurality of the events and storing same in a storage medium;
wherein, in the grouping step, at each time that a mode which is set in the machine tool is switched, one event or two or more events that are generated during the set mode are grouped together and stored.

2. The operation management method for the machine tool according to claim 1, wherein modes of the machine tool include at least two modes from among a manual feeding mode, an editing mode, and an automatic machining mode.

3. The operation management method for the machine tool according to claim 2, wherein in the grouping step, in a case that the mode of the machine tool is the automatic machining mode, in each of respective machining cycles, one event or two or more events that are generated and collected during the machining cycle are grouped together.

4. The operation management method for the machine tool according to claim 1, further comprising a list displaying step of displaying in a list on a display unit a plurality of grouped events that are stored in the storage medium.

5. The operation management method for the machine tool according to claim 4, further comprising an information adding step of associating with and storing in a designated group, supplemental information for the group that has been designated and input by an operator.

6. The operation management method for the machine tool according to claim 4, further comprising:
a selecting step of selecting, in response to an operation of an operator, any one of the groups from among the plurality of groups;
an extracting step of extracting one of the groups having an event that is similar in content with an event of the selected group; and
a displaying step of displaying the extracted group.

7. The operation management method for the machine tool according to claim 1, wherein the events include at least one of an alarm and a change in an operation state, generated by an operation.

8. The operation management method for the machine tool according to claim 1, wherein:
the operation management method manages operations of a plurality of machine tools;
in the collecting step, events are collected that occur in each of the machine tools; and
in the grouping step, for each of the machine tools, a collected plurality of the events are divided into a plurality of the groups and stored in the storage medium.
